(19) United States
(12) Patent Application Publication
(10) Pub. No.: US 2024/0309621 A1
(43) Pub. Date: Sep. 19, 2024

(54) FITTING

(71) Applicant: BLANCO GMBH + CO KG, Oberderdingen (DE)

(72) Inventors: Oliver Kuch, Oberderdingen (DE); Ozkan KAYA, Kraichtal (DE); Marcel MORITZ, Oberderdingen (DE)

(73) Assignee: BLANCO GMBH + CO KG, Oberderdingen (DE)

(21) Appl. No.: 18/604,869

(22) Filed: Mar. 14, 2024

(30) Foreign Application Priority Data
Mar. 15, 2023 (DE) 10 2023 202 353.9

(51) Int. Cl. E03C 1/04; F16B 1/00

(52) U.S. Cl. CPC E03C 1/0404; F16B 1/00; E03C 2001/0415; F16B 2200/83

(57) ABSTRACT

The invention relates to a fitting, in particular a sanitary fitting, comprising a main body, a first component in the form of an arm arranged on the main body, a second component in the form of a flexible outlet arranged on the main body, wherein the second component can be detachably secured to the first component, by means of a projection on one of the two components, which engages in at least one recess in the other of the two components, the two components can be secured against rotation and displacement by means of a detachable connection.

The invention relates to a fitting, in particular a sanitary fitting, comprising a main body, a first component in the form of an arm arranged on the main body, a second component in the form of a flexible outlet arranged on the main body, wherein the second component can be detachably fixed to the first component.

Although the present invention can be generally applied to any fittings, the present invention is explained in relation to sanitary fittings.

A sanitary fitting is known, for example, from EP 3 276 090 B1. The sanitary fitting comprises a base, a hose shower and an arm held on the base, the arm comprising a hose shower holder on which the hose shower is detachably held in a rest position. For this purpose, the hose shower comprises a retaining section which is designed to complement a hose shower receptacle of the arm, at least in sections, and is preferably designed in a way that it can be detachably secured to the hose shower receptacle in the rest position of the hose shower. The detachable fixing of the holding section of the hose shower to the hose shower holder of the arm can be achieved, for example, by positive locking and/or by force locking. In particular, it can be provided that the holding section can be fixed to the hose shower holder by magnetic force.

The disadvantage here is that the hose shower can only be fixed in terms of its vertical direction. However, the cylindrical shower head can twist due to the inherent tension of the spring and/or the shower hose, as it is only held magnetically in the round hose shower holder and is not fixed in a defined position. The shower and the control button for the shower changeover can therefore be arbitrarily twisted or moved in a position that is unergonomic for the user. In addition, a high value is reduced by the disadvantageous visual impression.

An object of the present invention is therefore to provide a reliable and at the same time defined arrangement with an appealing visual impression and low cost.

A further object of the present invention is to provide an alternative fitting, in particular a sanitary fitting.

In one embodiment, the present invention solves the above-mentioned objects in a fitting, in particular a sanitary fitting, comprising a main body, a first component in the form of an arm arranged on the main body, a second component in the form of a flexible outlet arranged on the main body, the second component can be detachably attached to the first component, in that by means of a projection on one of the two components, which engages in at least one recess in the other of the two components, the two components can be secured to each other against rotation and displacement by means of a detachable connection.

The term “sanitary” is to be understood in the broadest sense and refers, in particular in the description, preferably in the claims, among others, to any objects, arrangements, devices, equipment and the like in connection with bathrooms, kitchens, heating systems and the like.

The term “displacement-secure” is to be understood in the broadest sense and refers, particularly in the description, preferably in the claims, to a displaceability along at least one, in particular two directions, which is prevented, inhibited and/or suppressed.

The term “recess” is to be understood in the broadest sense and refers, in particular in the description, preferably in the claims, to an opening, recess or the like which has a peripheral edge, boundary or the like. The term “recess”, in particular in the description, preferably in the claims, does not mean recesses which are open in cross-section in one direction, for example are U-shaped, and thus do not have a circumferential edge or a completely circumferential boundary.

One of the advantages achieved with this is that a high visual appeal, a reliable and defined fixation as well as a simple, defined operation of the fitting, in particular the flexible outlet, are made possible.

Further features, advantages and further embodiments are described below or are disclosed thereby.

According to a preferred embodiment of the invention, the detachable connection can be provided by means of a non-positive connection, in particular by means of magnetic force. The advantage of this is that it is easy to detach and at the same time reliable.

The strength of the force-locking connection can be designed in such a way that a user can feel a force acting on the second component even at a predefined distance and the second and first components can “find each other”, which further improves user satisfaction and usability.

According to another preferred embodiment of the invention, one of the components is magnetic, in particular the second component, and the other component, in particular the first component, has at least one magnet. This provides a simple and reliable non-positive connection. At the same time, the magnetic force can be easily specified or adapted to the respective conditions. Preferably, the one component, in particular the second component, can be made of a magnetic material, for example a metal or the like. In particular, a neodymium magnet can be used as a magnet.

According to another preferred embodiment of the invention, the projection is designed as a magnet. The advantage of this is that the protrusion can be easily formed to provide magnetic force.

According to another preferred embodiment of the invention, the projection and/or the recess is provided with a protective cap, in particular made of plastic. On the one hand, this makes it possible to reduce damage during fixing, and on the other hand, greater tolerances are possible when forming the recess.

According to another preferred embodiment of the invention, the cross-section of the projection and/or recess has at least one corner, in particular at least three corners, in particular four corners, and is in particular square or rectangular in shape. The advantage of this is that security against rotation and/or displacement can be provided in a simple manner.

According to another preferred embodiment of the invention, the two components can be fixed to each other at least partially by a circumferential gap. This prevents, for example, direct contact between the two components, especially their surfaces, which prevents damage to the surfaces. The two components are then only connected to each other via the projection, which engages in the corresponding recess.

According to another preferred embodiment of the invention, the projection has a greater depth in the insertion direction than the recess for forming the gap. This makes it particularly easy to create a gap between the two components, with the exception of the projection that engages in the recess.

According to another preferred embodiment of the invention, the gap has a size of 0.5 mm or more, preferably 1 mm or more, in particular 2 mm or more, and 10 mm or less, preferably 5 mm or less, in particular 3 mm or less. One of the advantages of this is that, in addition to a high visual quality, scratching of the two components is avoided. In addition, simple actuation of the two components is made possible.

According to another preferred embodiment of the invention, several recesses are arranged. The advantage of this is increased flexibility for the user when fixing the two components together.

According to another preferred embodiment of the invention, the recesses are arranged at a distance from one another in the vertical direction, in particular lying on a common axis. This enables reliable height adjustment in a simple manner while simultaneously fixing the two components to each other.

According to another preferred embodiment of the invention, the at least one recess is formed along a direction larger than the projection in such a way that the projection can be freely arranged within the recess. The advantage of this is that a limited amount of movement between the two components is permitted. A user therefore does not have to loosen the detachable connection if, for example, they want to change the height at which the second component is fixed to the first component.

According to a further preferred embodiment of the invention, the flexible outlet is designed in the form of a hose shower. This allows flexible handling of the second component by a user.

According to another preferred embodiment of the invention, the second component has an actuating device for actuating the sanitary fitting, which is arranged in particular on the side of the second component facing away from the first component. This enables a simple and direct actuation of the sanitary fitting by a user, with particularly easy access to the actuating device.

Other important features and advantages of the invention result from the dependent claims, from the drawings and the corresponding description of the figures using the drawings.

It is understood that the above-mentioned features, and features yet to be explained below, may be used not only in the respectively indicated combination, but rather also in other combinations or alone, without departing from the scope of the present invention.

Preferred designs and embodiments of this invention are shown in the accompanying drawings and are explained in more detail in the following description, wherein identical reference numbers refer to identical or similar or functionally identical components or elements.

In the form of a diagram,

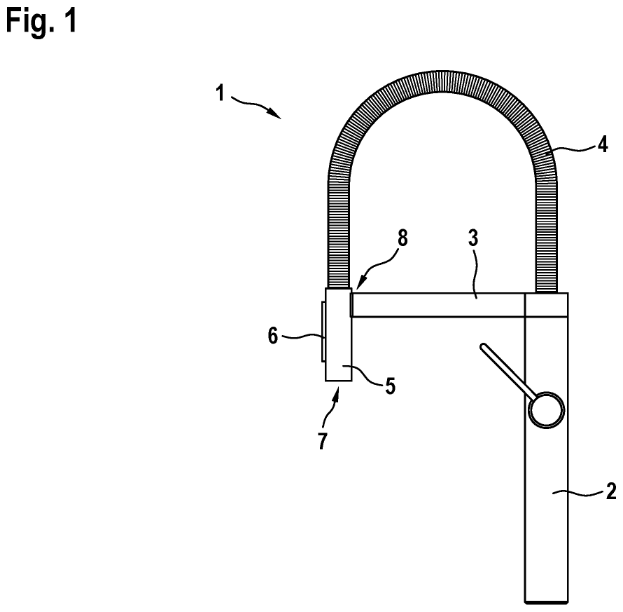

FIG. 1 a fitting according to an embodiment of the present invention;

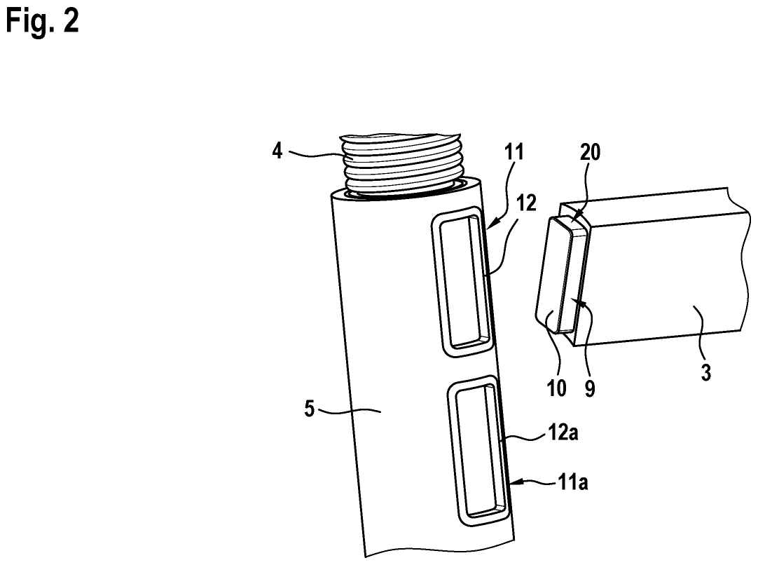

FIG. 2 the fitting according to FIG. 1 with first and second component detached from each other according to an embodiment of the present invention in three-dimensional representation; and

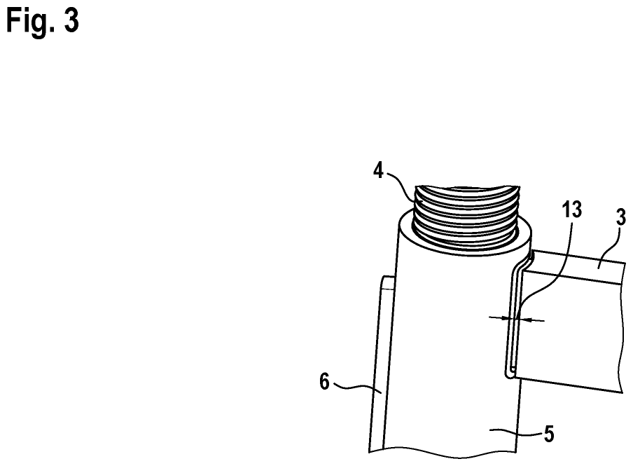

FIG. 3 three-dimensional representation of the fitting according to FIG. 1 with the first and second components fixed together according to one embodiment of the present invention.

FIG. 1 shows a fitting according to an embodiment of the present invention.

A sanitary fitting 1 is shown in FIG. 1. The sanitary fitting 1 comprises a main body 2 or base, a hose shower 4 and a support arm 3 held horizontally on the main body 2, wherein the hose shower 4 with its shower head 5 with outlet 7 is detachably held on the support arm 3 in a rest position by means of a detachable connection 8. A button 6 for triggering the water flow from the outlet 7 of the shower head 5 is arranged on the side of the shower head 5 facing away from the support arm 3.

FIG. 2 shows the fitting according to FIG. 1 with first and second component detached from each other according to an embodiment of the present invention in three-dimensional representation and FIG. 3 shows the fitting according to FIG. 1 with first and second component fixed to each other according to an embodiment of the present invention in three-dimensional representation.

In FIGS. 2 and 3, the support arm 3 has a rectangular cross section. At its end facing away from the main body 2 (not shown), the support arm 3 has a projection 20 in the form of a cuboid magnet 9, which is provided with a correspondingly designed protective cap 10.

The shower head 5 has a corresponding first recess 11 and a corresponding second recess 11a, each of which is provided with a protective insert 12, 12a. The protective cap 10 and protective insert 12, 12a can be made of plastic and are designed in such a way that the protective cap 10 can be inserted into the protective insert 12, 12a with a positive fit. In addition, the shower head 5 is made of magnetic material or has at least partially magnetic material, in particular in the area of the recesses 11, 11a, so that when the magnet 9 is inserted into the respective recess 11, 11a, a force-fit, detachable connection based on magnetic force can be produced. In the position in which the shower head 5 is fixed to the support arm 3, the shower head 5 and support arm 3 are spaced apart from one another except for the fixation via the projection 20 which engages in the recess 11, 11a. In particular, a circumferential gap 13 is formed on the radially outer side of the projection 20, which distances the shower head 5 and the support arm 3 from one another. The gap 13 can be between 1 mm and 5 mm.

If a user wishes to arrange the shower head 5 in a higher position, they can use the second recess 11a to engage the projection 20, which is arranged vertically below the first recess 11. However, it is also conceivable to arrange the first and second recesses 11, 11a offset to one another in the circumferential direction of the cylindrical shower head 5.

In summary, at least one of the embodiments of the invention may achieve at least one of the following features and/or at least one of the following advantages:
Support arm of the fitting with integrated magnet.
The magnet is protected by a plastic cap.
Shower head with magnetic counterpart and correspondingly pronounced recess for holding the magnet from the arm. This is also protected by a plastic insert.
Reduces damage to the surfaces of the shower head and support arm.
Noise reduction through protective elements, especially made of plastic.
High-quality optical impression.
Reliable and defined specification.
Simple, defined actuation of the fitting.
Simple and cost-effective manufacture.

Although the present invention was described using preferred embodiments, it is not limited to these, but rather may be modified in various ways.

### LIST OF REFERENCE SIGNS

1 Sanitary fitting
2 Main body
3 Support arm
4 Hose shower
5 Shower head
6 Button
7 Outlet
8 Detachable connection
9 Magnet
10 Protective cap
11, 11a Recess
12, 12a Protective insert
13 Gap
20 Projection

1. A fitting, in particular a sanitary fitting, comprising
a main body,
a first component in the form of an arm arranged on the main body,
a second component in the form of a flexible outlet arranged on the main body, wherein the second component can be detachably secured to the first component, characterized in that by means of a projection on one of the two components, which engages in at least one recess in the other of the two components, the two components can be secured against rotation and displacement by means of a detachable connection.

2. The fitting according to claim 1, characterised in that the detachable connection can be provided by means of a non-positive connection, in particular by means of magnetic force.

3. The fitting according to claim 2, characterised in that one of the components is magnetic, in particular the second component, and in that the other component, in particular the first component, has at least one magnet.

4. The fitting according to claim 3, characterised in that the projection is designed as a magnet.

5. The fitting according to claim 1, characterised in that the projection and/or the recess is provided with a protective cap, in particular made of plastic.

6. The fitting according to claim 1, characterised in that the cross-section of projection and/or recess has at least one corner, in particular at least three corners, in particular four corners, and is in particular square or rectangular in shape.

7. The fitting according to claim 1, characterised in that the two components can be fixed to one another at least partially by a circumferential gap.

8. The fitting according to claim 7, characterised in that in the direction of insertion the projection has a greater depth than the recess for forming the gap.

9. The fitting according to claim 7, characterised in that the gap has a size of 0.5 mm or more, preferably 1 mm or more, in particular 2 mm or more, and 10 mm or less, preferably 5 mm or less, in particular 3 mm or less.

10. The fitting according to claim 1, characterised in that a plurality of recesses are arranged.

11. The fitting according to claim 10, characterised in that the recesses are arranged at a distance from one another in the vertical direction, in particular lying on a common axis.

12. The fitting according to claim 1, characterised in that the at least one recess is formed along a direction larger than the projection in such a way that the projection can be freely arranged within the recess.

13. The fitting according to claim 1, characterised in that the flexible outlet is in the form of a hose shower.

14. The fitting according to claim 1, characterised in that the second component has an actuating device for actuating the sanitary fitting, which is arranged in particular on the side of the second component facing away from the first component.
